(19) United States
(12) Patent Application Publication
(10) Pub. No.: US 2019/0227192 A1
(43) Pub. Date: Jul. 25, 2019

(54) Drilling Geomechanics Salt Creep Monitoring

(71) Applicant: Schlumberger Technology Corporation, Sugar Land, TX (US)

(72) Inventors: Joao Paulo Castagnoli, Rogaland (NO); Cyrille Montesinos, Baku (AZ); Diego Armando Munoz Sanchez, Poza Rica (MX)

(21) Appl. No.: 16/330,753

(22) PCT Filed: Sep. 7, 2017
(86) PCT No.: PCT/US17/50523

§ 371 Date: Mar. 5, 2019

Related U.S. Application Data
(60) Provisional application No. 62/384,361, filed on Sep. 7, 2016.

(51) Int. Cl. G01V 99/00; G01V 11/00

(52) U.S. Cl. CPC G01V 99/005; G01V 11/002

(57) ABSTRACT

A method for monitoring salt creep while drilling includes obtaining data representing a subterranean domain, the subterranean domain comprising a salt layer, obtaining an initial model of salt creep for a well penetrating the salt layer, generating a second model of salt creep by revising the initial model while drilling the well based on measurements collected in the well, and determining one or more revised drilling parameters using the second model while drilling the well.

### CROSS-REFERENCE TO RELATED APPLICATIONS

This application claims priority to U.S. Provisional Patent Application having Ser. No. 62/384,361, filed on Sep. 7, 2016, which is incorporated herein by reference in its entirety.

### BACKGROUND

Oil and gas plays are sometimes associated with salt structures; however, drilling through salt is often avoided because of the challenges associated therewith. In the Gulf of Mexico (GoM), for example, salt is primarily a massive halite deposit averaging 96% purity, with some occasional trapped sediment inclusions. The impurities are classified into three categories: anhydrite, other evaporates (sylvite, gypsum and carnalite), and other impurities (quartz, dolomite, feldspar, and clay). These inclusions may be affected by creep mechanisms; inclusions surrounded by highly mobile salt tend to be more unstable or can contain overpressure. Salt deposits may be non-radioactive, non-porous, low density, high velocity, electrically nonconductive and soluble.

Some oil and gas plays are located below salt bodies. To reach the hydrocarbon section, drillers are called upon to drill through thick salt layers, e.g., up to 6000 m (about 20,000 ft). The salt can exhibit considerable deformation when drilled. This deformation may be a function of the magnitude of in-situ stresses, mud density, exposure time, temperature and the mineralogical composition. The process causing the deformation is known as “salt creep.”

Salt creep effects may complicate well construction in salt formations. For example, salt creep may result in excessive torque, pack offs, stuck pipes, casing running blockage, and poor cementing jobs. In addition, the salt exit may have a rubble zone where mud losses and wellbore instability are seen.

Challenges from salt creep and salt exit are generally addressed by appropriate selection of mud weight and other mud properties. For example, drillers may utilize tables with recommended mud weights to drill salt sections. However, when salt creep is underestimated, non-productive time and expensive additional rig time may be called for to correct for the inadequate salt creep estimation.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Embodiments of the disclosure may provide a method including obtaining data representing a subterranean domain, the subterranean domain comprising a salt layer, obtaining an initial model of salt creep for a well penetrating the salt layer, generating a second model of salt creep by revising the initial model while drilling the well based on measurements collected in the well, and determining one or more revised drilling parameters using the second model while drilling the well.

Embodiments of the disclosure may also provide a computing system including one or more processors a memory system including one or more non-transitory computer-readable media storing instructions that, when executed by at least one of the one or more processors, cause the computing system to perform operations, the operations including obtaining data representing a subterranean domain, the subterranean domain comprising a salt layer, obtaining an initial model of salt creep for a well penetrating the salt layer, generating a second model of salt creep by revising the initial model while drilling the well based on measurements collected in the well, and determining one or more revised drilling parameters using the second model while drilling the well.

Embodiments of the disclosure may further provide a non-transitory computer-readable media storing instructions that, when executed by at least one processors, cause a computing system to perform operations, the operations including obtaining data representing a subterranean domain, the subterranean domain comprising a salt layer, obtaining an initial model of salt creep for a well penetrating the salt layer, generating a second model of salt creep by revising the initial model while drilling the well based on measurements collected in the well, and determining one or more revised drilling parameters using the second model while drilling the well.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIGS. 1A, 1B, 1C, 1D, 2, 3A, and 3B illustrate simplified, schematic views of an oilfield and its operation, according to an embodiment.

FIG. 4 illustrates a flowchart of a method for determining drilling parameters while accounting for salt creep, according to an embodiment.

FIG. 5A illustrate a plot of time-of-exposure logs for every meter drilled where salt is present and radial closure model, according to an embodiment.

FIG. 5B illustrates a schematic view of a well, according to an embodiment.

FIG. 5C illustrate another plot of time-of-exposure logs for every meter drilled where salt is present and radial closure model, according to an embodiment.

FIGS. 6A and 6B illustrate plots of borehole diameter curves generated using Barker and Von Mises elasto-viscoplastic models, respectively, and considering the same input and 100% halite, n=4.5, according to an embodiment.

FIGS. 7A and 7B illustrate plots of Borehole diameter curve with Barker and Von Mises elasto-viscoplastic models, respectively, considering the same input and 100% carnalite, n=5.05, according to an embodiment.

FIGS. 8A and 8B illustrate plots of borehole salt closure velocities with different salt creep models considering the same well condition, according to an embodiment.

FIG. 9 illustrates a schematic view of a computing system, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object could be termed a second object, and, similarly, a second object could be termed a first object, without departing from the scope of the invention. The first object and the second object are both objects, respectively, but they are not to be considered the same object.

The terminology used in the description of the invention herein is for the purpose of describing particular embodiments only and is not intended to be limiting of the invention. As used in the description of the invention and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques and workflows that are in accordance with some embodiments. Some operations in the processing procedures, methods, techniques and workflows disclosed herein may be combined and/or the order of some operations may be changed.

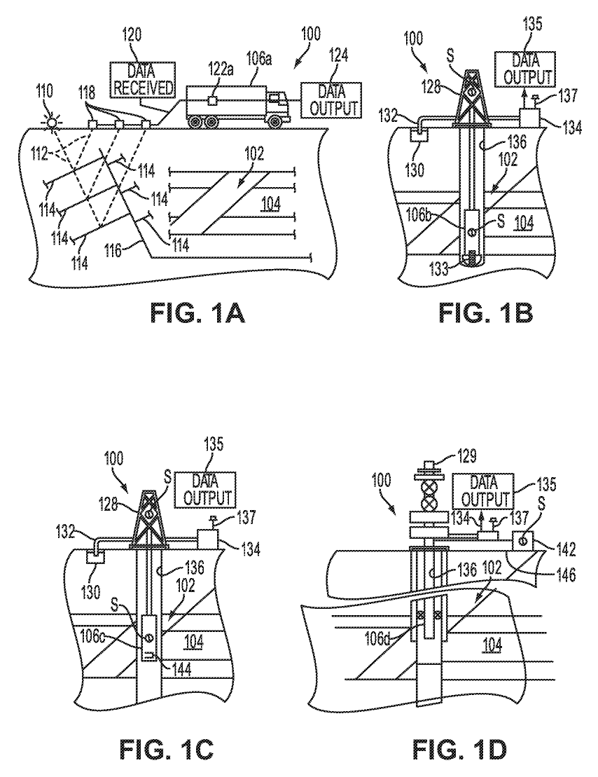

FIGS. 1A-1D illustrate simplified, schematic views of oilfield 100 having subterranean formation 102 containing reservoir 104 therein in accordance with implementations of various technologies and techniques described herein. FIG. 1A illustrates a survey operation being performed by a survey tool, such as seismic truck 106.1, to measure properties of the subterranean formation. The survey operation is a seismic survey operation for producing sound vibrations. In FIG. 1A, one such sound vibration, e.g., sound vibration 112 generated by source 110, reflects off horizons 114 in earth formation 116. A set of sound vibrations is received by sensors, such as geophone-receivers 118, situated on the earth's surface. The data received 120 is provided as input data to a computer 122.1 of a seismic truck 106.1, and responsive to the input data, computer 122.1 generates seismic data output 124. This seismic data output may be stored, transmitted or further processed as desired, for example, by data reduction.

FIG. 1B illustrates a drilling operation being performed by drilling tools 106.2 suspended by rig 128 and advanced into subterranean formations 102 to form wellbore 136. Mud pit 130 is used to draw drilling mud into the drilling tools via flow line 132 for circulating drilling mud down through the drilling tools, then up wellbore 136 and back to the surface. The drilling mud is typically filtered and returned to the mud pit. A circulating system may be used for storing, controlling, or filtering the flowing drilling mud. The drilling tools are advanced into subterranean formations 102 to reach reservoir 104. Each well may target one or more reservoirs. The drilling tools are adapted for measuring downhole properties using logging while drilling tools. The logging while drilling tools may also be adapted for taking core sample 133 as shown.

Computer facilities may be positioned at various locations about the oilfield 100 (e.g., the surface unit 134) and/or at remote locations. Surface unit 134 may be used to communicate with the drilling tools and/or offsite operations, as well as with other surface or downhole sensors. Surface unit 134 is capable of communicating with the drilling tools to send commands to the drilling tools, and to receive data therefrom. Surface unit 134 may also collect data generated during the drilling operation and produce data output 135, which may then be stored or transmitted.

Sensors (S), such as gauges, may be positioned about oilfield 100 to collect data relating to various oilfield operations as described previously. As shown, sensor (S) is positioned in one or more locations in the drilling tools and/or at rig 128 to measure drilling parameters, such as weight on bit, torque on bit, pressures, temperatures, flow rates, compositions, rotary speed, and/or other parameters of the field operation. Sensors (S) may also be positioned in one or more locations in the circulating system.

Drilling tools 106.2 may include a bottom hole assembly (BHA) (not shown), generally referenced, near the drill bit (e.g., within several drill collar lengths from the drill bit). The bottom hole assembly includes capabilities for measuring, processing, and storing information, as well as communicating with surface unit 134. The bottom hole assembly further includes drill collars for performing various other measurement functions.

The bottom hole assembly may include a communication subassembly that communicates with surface unit 134. The communication subassembly is adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

Typically, the wellbore is drilled according to a drilling plan that is established prior to drilling. The drilling plan typically sets forth equipment, pressures, trajectories and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected

The data gathered by sensors (S) may be collected by surface unit 134 and/or other data collection sources for analysis or other processing. The data collected by sensors (S) may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis. The data may be stored in separate databases, or combined into a single database.

Surface unit 134 may include transceiver 137 to allow communications between surface unit 134 and various portions of the oilfield 100 or other locations. Surface unit 134 may also be provided with or functionally connected to one or more controllers (not shown) for actuating mechanisms at oilfield 100. Surface unit 134 may then send command signals to oilfield 100 in response to data received. Surface unit 134 may receive commands via transceiver 137 or may itself execute commands to the controller. A processor may be provided to analyze the data (locally or remotely), make the decisions and/or actuate the controller. In this manner, oilfield 100 may be selectively adjusted based on the data collected. This technique may be used to optimize (or improve) portions of the field operation, such as controlling drilling, weight on bit, pump rates, or other parameters. These adjustments may be made automatically based on computer protocol, and/or manually by an operator. In some cases, well plans may be adjusted to select optimum (or improved) operating conditions, or to avoid problems.

FIG. 1C illustrates a wireline operation being performed by wireline tool 106.3 suspended by rig 128 and into wellbore 136 of FIG. 1B. Wireline tool 106.3 is adapted for deployment into wellbore 136 for generating well logs, performing downhole tests and/or collecting samples. Wireline tool 106.3 may be used to provide another method and apparatus for performing a seismic survey operation. Wireline tool 106.3 may, for example, have an explosive, radioactive, electrical, or acoustic energy source 144 that sends and/or receives electrical signals to surrounding subterranean formations 102 and fluids therein.

Wireline tool 106.3 may be operatively connected to, for example, geophones 118 and a computer 122.1 of a seismic truck 106.1 of FIG. 1A. Wireline tool 106.3 may also provide data to surface unit 134. Surface unit 134 may collect data generated during the wireline operation and may produce data output 135 that may be stored or transmitted. Wireline tool 106.3 may be positioned at various depths in the wellbore 136 to provide a survey or other information relating to the subterranean formation 102.

Sensors (S), such as gauges, may be positioned about oilfield 100 to collect data relating to various field operations as described previously. As shown, sensor S is positioned in wireline tool 106.3 to measure downhole parameters which relate to, for example porosity, permeability, fluid composition and/or other parameters of the field operation.

FIG. 1D illustrates a production operation being performed by production tool 106.4 deployed from a production unit or Christmas tree 129 and into completed wellbore 136 for drawing fluid from the downhole reservoirs into surface facilities 142. The fluid flows from reservoir 104 through perforations in the casing (not shown) and into production tool 106.4 in wellbore 136 and to surface facilities 142 via gathering network 146.

Sensors (S), such as gauges, may be positioned about oilfield 100 to collect data relating to various field operations as described previously. As shown, the sensor (S) may be positioned in production tool 106.4 or associated equipment, such as Christmas tree 129, gathering network 146, surface facility 142, and/or the production facility, to measure fluid parameters, such as fluid composition, flow rates, pressures, temperatures, and/or other parameters of the production operation.

Production may also include injection wells for added recovery. One or more gathering facilities may be operatively connected to one or more of the wellsites for selectively collecting downhole fluids from the wellsite(s).

While FIGS. 1B-1D illustrate tools used to measure properties of an oilfield, it will be appreciated that the tools may be used in connection with non-oilfield operations, such as gas fields, mines, aquifers, storage or other subterranean facilities. Also, while certain data acquisition tools are depicted, it will be appreciated that various measurement tools capable of sensing parameters, such as seismic two-way travel time, density, resistivity, production rate, etc., of the subterranean formation and/or its geological formations may be used. Various sensors (S) may be located at various positions along the wellbore and/or the monitoring tools to collect and/or monitor the desired data. Other sources of data may also be provided from offsite locations.

The field configurations of FIGS. 1A-1D are intended to provide a brief description of an example of a field usable with oilfield application frameworks. Part of, or the entirety, of oilfield 100 may be on land, water and/or sea. Also, while a single field measured at a single location is depicted, oilfield applications may be utilized with any combination of one or more oilfields, one or more processing facilities and one or more wellsites.

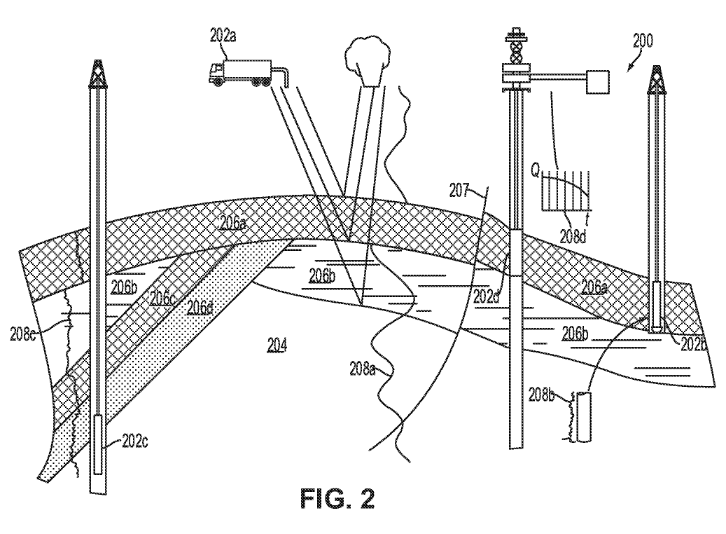

FIG. 2 illustrates a schematic view, partially in cross section of oilfield 200 having data acquisition tools 202.1, 202.2, 202.3 and 202.4 positioned at various locations along oilfield 200 for collecting data of subterranean formation 204 in accordance with implementations of various technologies and techniques described herein. Data acquisition tools 202.1-202.4 may be the same as data acquisition tools 106.1-106.4 of FIGS. 1A-1D, respectively, or others not depicted. As shown, data acquisition tools 202.1-202.4 generate data plots or measurements 208.1-208.4, respectively. These data plots are depicted along oilfield 200 to demonstrate the data generated by the various operations.

Data plots 208.1-208.3 are examples of static data plots that may be generated by data acquisition tools 202.1-202.3, respectively; however, it should be understood that data plots 208.1-208.3 may also be data plots that are updated in real time. These measurements may be analyzed to better define the properties of the formation(s) and/or determine the accuracy of the measurements and/or for checking for errors. The plots of each of the respective measurements may be aligned and scaled for comparison and verification of the properties.

Static data plot 208.1 is a seismic two-way response over a period of time. Static plot 208.2 is core sample data measured from a core sample of the formation 204. The core sample may be used to provide data, such as a graph of the density, porosity, permeability, or some other physical property of the core sample over the length of the core. Tests for density and viscosity may be performed on the fluids in the core at varying pressures and temperatures. Static data plot 208.3 is a logging trace that typically provides a resistivity or other measurement of the formation at various depths.

A production decline curve or graph 208.4 is a dynamic data plot of the fluid flow rate over time. The production decline curve typically provides the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes in formation aspects over time.

The subterranean structure 204 has a plurality of geological formations 206.1-206.4. As shown, this structure has several formations or layers, including a shale layer 206.1, a carbonate layer 206.2, a shale layer 206.3 and a sand layer 206.4. A fault 207 extends through the shale layer 206.1 and the carbonate layer 206.2. The static data acquisition tools are adapted to take measurements and detect characteristics of the formations.

While a specific subterranean formation with specific geological structures is depicted, it will be appreciated that oilfield 200 may contain a variety of geological structures and/or formations, sometimes having extreme complexity. In some locations, typically below the water line, fluid may occupy pore spaces of the formations. Each of the measurement devices may be used to measure properties of the formations and/or its geological features. While each acquisition tool is shown as being in specific locations in oilfield 200, it will be appreciated that one or more types of measurement may be taken at one or more locations across one or more fields or other locations for comparison and/or analysis.

The data collected from various sources, such as the data acquisition tools of FIG. 2, may then be processed and/or evaluated. Typically, seismic data displayed in static data plot 208.1 from data acquisition tool 202.1 is used by a geophysicist to determine characteristics of the subterranean formations and features. The core data shown in static plot 208.2 and/or log data from well log 208.3 are typically used by a geologist to determine various characteristics of the subterranean formation. The production data from graph 208.4 is typically used by the reservoir engineer to determine fluid flow reservoir characteristics. The data analyzed by the geologist, geophysicist and the reservoir engineer may be analyzed using modeling techniques.

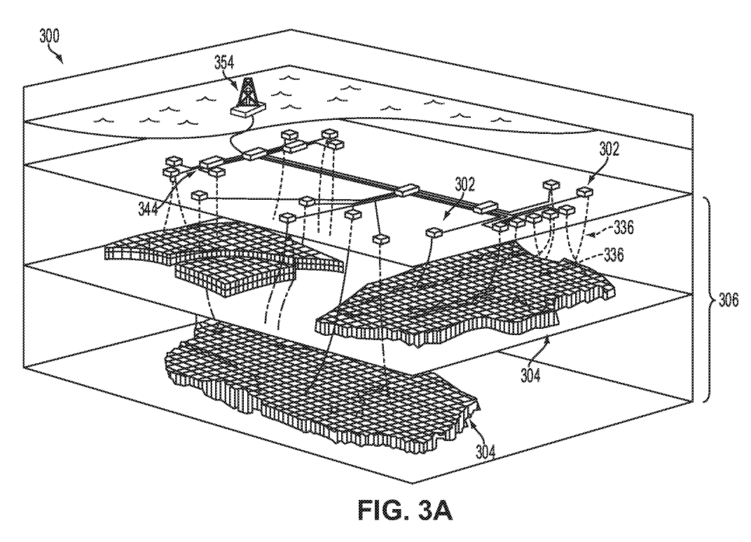

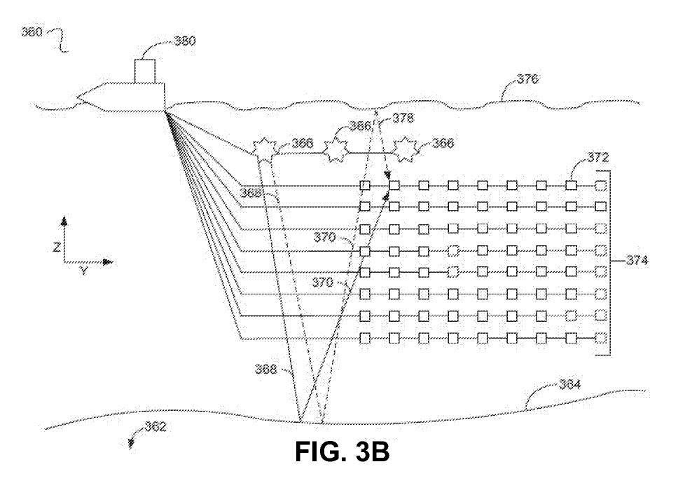

FIG. 3A illustrates an oilfield 300 for performing production operations in accordance with implementations of various technologies and techniques described herein. As shown, the oilfield has a plurality of wellsites 302 operatively connected to central processing facility 354. The oilfield configuration of FIG. 3A is not intended to limit the scope of the oilfield application system. Part, or all, of the oilfield may be on land and/or sea. Also, while a single oilfield with a single processing facility and a plurality of wellsites is depicted, any combination of one or more oilfields, one or more processing facilities and one or more wellsites may be present.

Each wellsite 302 has equipment that forms wellbore 336 into the earth. The wellbores extend through subterranean formations 306 including reservoirs 304. These reservoirs 304 contain fluids, such as hydrocarbons. The wellsites draw fluid from the reservoirs and pass them to the processing facilities via surface networks 344. The surface networks 344 have tubing and control mechanisms for controlling the flow of fluids from the wellsite to processing facility 354.

Attention is now directed to FIG. 3B, which illustrates a side view of a marine-based survey 360 of a subterranean subsurface 362 in accordance with one or more implementations of various techniques described herein. Subsurface 362 includes seafloor surface 364. Seismic sources 366 may include marine sources such as vibroseis or airguns, which may propagate seismic waves 368 (e.g., energy signals) into the Earth over an extended period of time or at a nearly instantaneous energy provided by impulsive sources. The seismic waves may be propagated by marine sources as a frequency sweep signal. For example, marine sources of the vibroseis type may initially emit a seismic wave at a low frequency (e.g., 5 Hz) and increase the seismic wave to a high frequency (e.g., 80-90 Hz) over time.

The component(s) of the seismic waves 368 may be reflected and converted by seafloor surface 364 (i.e., reflector), and seismic wave reflections 370 may be received by a plurality of seismic receivers 372. Seismic receivers 372 may be disposed on a plurality of streamers (i.e., streamer array 374). The seismic receivers 372 may generate electrical signals representative of the received seismic wave reflections 370. The electrical signals may be embedded with information regarding the subsurface 362 and captured as a record of seismic data.

In one implementation, each streamer may include streamer steering devices such as a bird, a deflector, a tail buoy and the like, which are not illustrated in this application. The streamer steering devices may be used to control the position of the streamers in accordance with the techniques described herein.

In one implementation, seismic wave reflections 370 may travel upward and reach the water/air interface at the water surface 376, a portion of reflections 370 may then reflect downward again (i.e., sea-surface ghost waves 378) and be received by the plurality of seismic receivers 372. The sea-surface ghost waves 378 may be referred to as surface multiples. The point on the water surface 376 at which the wave is reflected downward is generally referred to as the downward reflection point.

The electrical signals may be transmitted to a vessel 380 via transmission cables, wireless communication or the like. The vessel 380 may then transmit the electrical signals to a data processing center. Alternatively, the vessel 380 may include an onboard computer capable of processing the electrical signals (i.e., seismic data). Those skilled in the art having the benefit of this disclosure will appreciate that this illustration is highly idealized. For instance, surveys may be of formations deep beneath the surface. The formations may typically include multiple reflectors, some of which may include dipping events, and may generate multiple reflections (including wave conversion) for receipt by the seismic receivers 372. In one implementation, the seismic data may be processed to generate a seismic image of the subsurface 362. Marine seismic acquisition systems tow each streamer in streamer array 374 at the same depth (e.g., 5-10 m). However, marine based survey 360 may tow each streamer in streamer array 374 at different depths such that seismic data may be acquired and processed in a manner that avoids the effects of destructive interference due to sea-surface ghost waves. For instance, marine-based survey 360 of FIG. 3B illustrates eight streamers towed by vessel 380 at eight different depths. The depth of each streamer may be controlled and maintained using the birds disposed on each streamer.

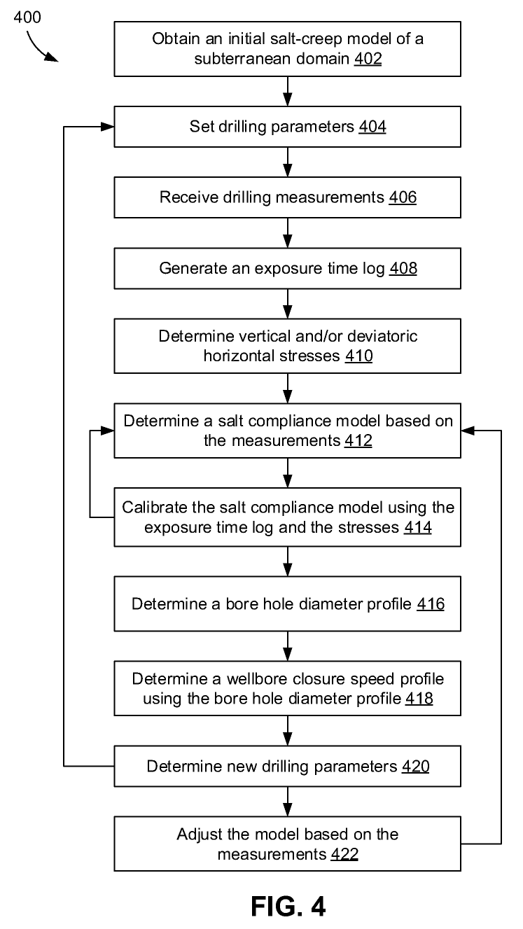

FIG. 4 illustrates a flowchart of a method 400 for selecting drilling parameters, borehole diameters, etc., e.g., while drilling a wellbore, according to an embodiment. In particular, the method 400 may account for salt creep. Further, the method 400 may be iterative, as the drilling parameters may serve as both input and output. Illustrative drilling parameters include borehole depth, borehole diameter, mud weight, and rate of penetration, among others. For example, in a specific embodiment, the method 400 may enable the calculation of wellbore diameter as a function of time exposure, using, e.g., two analytical models (such as the Barker and Liu equations, discussed in greater detail below).

The method 400 may include obtaining an initial salt-creep model of a subterranean domain, as at 402. This may be a theoretical model of salt creep based on data collected prior to drilling the well, e.g., from offset wells, seismic surveys, and other sources of information about the subterranean domain, as detailed by way of example above. This model may allow for setting or may otherwise inform the setting of initial drilling parameters, as at 404, with such parameters being subject to refinement/calibration by implementation of the present method 400. Further, such setting make take place automatically or through interaction with engineers, operators, etc. Drilling parameters may include rate-of-penetration (ROP), casing depth, torque profiles, borehole diameter profile, etc.

With the initial drilling parameters set, drilling may commence, and the method 400 may also include receiving drilling measurements, as at 406. The drilling measurements may include measurements taken while drilling the wellbore, e.g., using logging-while-drilling (LWD) and/or measuring-while-drilling (MWD) equipment. The measurements may also or instead include analyses of cuttings or conducted in the wellbore, which may provide insight into the salt mineralogy and composition of the rock (or salt) in the subterranean domain. The measurements received at 406 may be received in real-time, e.g., as the drilling occurs. In some embodiments, the measurements taken may include any combination or subset of static temperatures and gradients thereof, annular pressures and gradients thereof, weight-on-bit, torque, rate-of-penetration, etc. Further, based on the measurements, the minerealogical composition of the subterranean domain (or portions thereof) may be inferred.

Before and/or during drilling, the method 400 may include generating an exposure time log for a unit of depth (e.g., each meter) drilled in salt, as at 408, e.g., from the beginning of the drilling operation to the estimated casing time that is set during planning. If a reaming operation is applied, the time count may be restarted at the specific depth interval.

The method 400 may also include determining vertical and/or deviatoric horizontal stresses in the subterranean domain, as at 410. Based on the stresses and the measurements collected, the method 400 may also include determining a salt compliance model, as at 412, which may be or include an updated salt creep model generated in part based on the initial salt-creep model.

The salt compliance model may then be calibrated, as at 414. The calibration may be iterative, as shown, and may run in real-time, during drilling, until the model converges with measured conditions. Such calibration may include determining a torque and drag model and comparing with measured torque behavior over time and/or depth as well the torque off bottom in reaming operation. For example, such calibration may employ the time exposure log and the stress computation, as will be described in greater detail below.

Using the calibrated salt compliance model, the method 400 may include determining a bore hole diameter profile, as at 416. Such profile may specify bore diameters at depth or time intervals, and may specify total strain as a function of time. Further, the method 400 may include determining a wellbore closure speed profile, as at 418, based on the hole diameter profile. Such wellbore closure speed profile may be specified per depth intervals. The wellbore closure speed may be, for example, the change in hole diameter over the change in time.

The method 400 may also include determining one or more new drilling parameters (e.g., ROP, RPM, ESD), as at 420. As mentioned above, the method 400 may include determining hole diameter profiles, as based on this, drilling parameters may be set to control such hole diameters reduction. Further, based on the salt model and the borehole profile, other drilling parameters such as mud density, casing depth, intervals to ream, and rate-of-penetration may also be calculated. The provision of such drilling parameters at 420 may also be iterative or may be constrained by pre-existing (e.g., tolerable and/or accomplishable) ranges, e.g., as dictated by equipment on hand, risk, etc. Once the new drilling parameters are set, they may be fed back as the drilling parameters at 404 for subsequent runs of the method 400, e.g., in real-time during drilling.

In some embodiments, the salt model may be revised either in real-time or off-line based on measurements taken during the drilling process, as at 422. Such revisions may be fed back to the salt model either at 402 or 412, as shown.

As explanation, salt rocks, also called evaporites, exhibit a creeping behavior due to the crystalline structure of the salt; the creep is defined as time-dependent permanent deformation when subjected to shear stress. Several constitutive models are used to simulate the time-dependent deformation under a constant deviatoric stress. This creep behavior may be influenced by the salt layer thickness, formation temperature, mineralogical composition, water content, presence of impurities, and the extent to which differential stresses are applied to the salt body. For mud weight determination and casing design, borehole creep using a finite element model that modeled the process while the borehole was excavated in stages. A power-law creep model may be used that includes a time-hardening component. The simulations may reveal that during salt movement, the radial and tangential stresses near the borehole decrease with time; however, the tangential stress far away from the borehole wall (at the radial distance of 10 to 20 borehole radii) may increase with time.

Further, the stress distribution around the wellbore may be approximated as elastic, allowing for the development of an analytical equation to allow engineering calculation at different stress, temperature, and closure-rate combinations. This equation is based on steady-state creep of salt formations and can be applied at any stress and temperature combination. This analytical equation express the radius of the well as a function of time:

$$R = {R}_{0} exp ( - \frac{{( \sqrt{3} )}^{( n + 1 )}}{4 n - 2} {{Ae}^{- \frac{B}{T}} ( {p}_{0} - {p}_{w} )}^{n} Δ t ) \qquad ( 1 )$$

where A is the salt constant, B is the temperature exponent of salt, T is the formation temperature, n is the stress exponent of salt, p₀ is the horizontal in-situ stress, p_{w} is the wellbore pressure, R is the radius after creep, R₀ is the original wellbore radius and Δt is the creep time or exposure time. Equation (1) may be referred to as “Baker's Equation.”

This solution may be used when designing mud weights, drilling parameters, cement, and casing to control salt creep. However, using finite element simulations, it may be determined that equation (1) overestimates the rate of borehole closure. Field experience has also suggested that the solution generated based on equation (1) produces pessimistic wellbore closure forecasts.

Another technique is to apply Perzyna's viscoplastic theory to derive a new analytical solution for borehole stresses and creep rates consistent with the Norton power-law model. The total strain rate is the sum of elastic and viscoplastic strain rate. The elastic strain rate is given by Hooke's law, and the viscoplastic creep strain rate can be calculated as a function of the fluidity parameter (γ), viscoplastic potential function (Q), and failure yield function (F). The viscoplastic strain model is shown in equation 2:

$${\dot{ɛ}}_{ij}^{c} = γ 〈 Φ ( F ) 〉 \frac{\partial Q}{\partial {σ}_{ij}} \qquad ( 2 )$$

Considering the associated viscoplastic flow rule (Q=F) used for salt material, the Von Mises elastic viscoplastic model assumes the failure yield function and the viscoplastic potential are a function of the equivalent stress (σ̅) and yield strength of material (σₛ):

F=Q=σ̅−σₛ (3)

To consider the effect of temperature on salt creep behavior, it may be assumed by correlation with equation (1) (Barker's methodology) that the fluidity parameter γ is given by

$$γ = {Ae}^{- \frac{B}{T}} \qquad ( 4 )$$

The new equation to determine the radius borehole closure for Von Mises elasto-viscoplastic model as a function of time is given by:

$$R = {R}_{0} exp ( - \frac{{( \sqrt{3} )}^{( n + 1 )}}{2 {n}^{n}} {{Ae}^{- \frac{B}{T}} ( {p}_{0} - {p}_{w} )}^{n} Δ t ) \qquad ( 5 )$$

The parameters are the same as in equation (1). The method 400 may thus simulate the salt creep, and thus may begin by building a salt-creep model and determining the input parameters using a predrill model from offset well or laboratory data associated with finite element analysis. The method 400 thus allows a comparison between the expected creep and real data to evaluate the real closure rate and define the appropriate model (as at 412) plus the parameters to fit the real behavior of the salt.

Some variables that define salt creeping are related to deviatoric stresses, temperature, mineralogical composition, and time exposure. During real-time monitoring, these variables may be controlled to provide accurate input for creep calculation. Overburden is updated with a measured or synthetic density log derived from offset wells based on the sonic log, formation temperature is estimated with geothermal gradient from offset wells (preferably those with salt sections that have a temperature measurement with WL tools), mineralogical composition is inferred from LWD logging tools and surface sample description, and time is clocked from the time of drilling each meter and estimating the time until casing is run and cemented.

In some areas, some of the salt impurities may be related to sediment inclusions with higher density compared to pure salt. Velocity increases slightly with depth, and the density of rock salt may not show a clear relationship with velocity; therefore, direct correlations may not be applied to define salt density. To estimate density in salt sediments, well logs may be reviewed in correlation wells and the density estimated for salt bodies. An empirical relationship may be established or utilized for velocity versus depth from the log data analysis. One way to obtain the density log data is to use the appropriate LWD or WL tools.

Salt formations may be assumed to have in-situ stresses equal in each direction and those stresses may equal the overburden (isotropic stress state considered). When salt sections are drilled with mud weight equivalent less than salt stresses, the salt may creep.

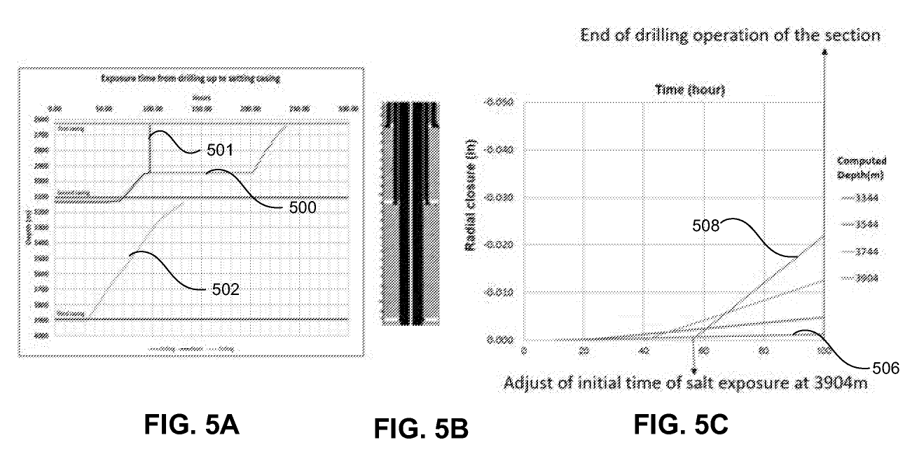

FIG. 5A illustrates the calculation of an exposure time log, according to an embodiment. The drilling time calculation is related to the estimated ROP based on correlation wells with similar conditions and updated with the real data. FIG. 5A, for example, shows the expected exposure time of each meter drilled in salt on the two well sections indicated in FIG. 5B. The time relation is one input for salt creep estimation (FIG. 5C).

FIG. 5C shows the radial closure estimation as a function of time correction exposure, meaning that the behavior of salt creep may be modeled as a function of real drilling progress. The prognosis may be estimated using the updated model, and new drilling time estimations (as a function of real ROP and drilling operations).

Considering equation (1) (“Barker's Equation”) and a homogenous with 100% of halite, FIG. 5A shows exposure time for two sections drilled in salt. On the vertical axis, drilled depth is shown, while horizontal axis displays the number of hours that elapsed from drilling to setting casing. Line 500 shows exposure time for first section drilled into salt. Because uncertainty in salt creeping velocity, one trip was done to ream drilled interval. After reaming that interval, initial borehole diameter is considered to be same as bit size and exposure time computation is restarted, as indicated by line 501.

Line 502 shows exposure time for another section drilled in salt after previous casing was set. This graph provides estimated time of exposure for salt sections which is an input parameter to calculate salt creep. FIG. 5C shows the change in borehole radius at given time for four different depths. Line 506 represents borehole radius closure at 3344 m TVD, the model shows that borehole closure is the lowest compared to other intervals (This is caused by lower overburden and lower temperature at shallower depth). Line 508 shows that borehole radius closure at 3904 m TVD happens at higher rates compared to shallower intervals.

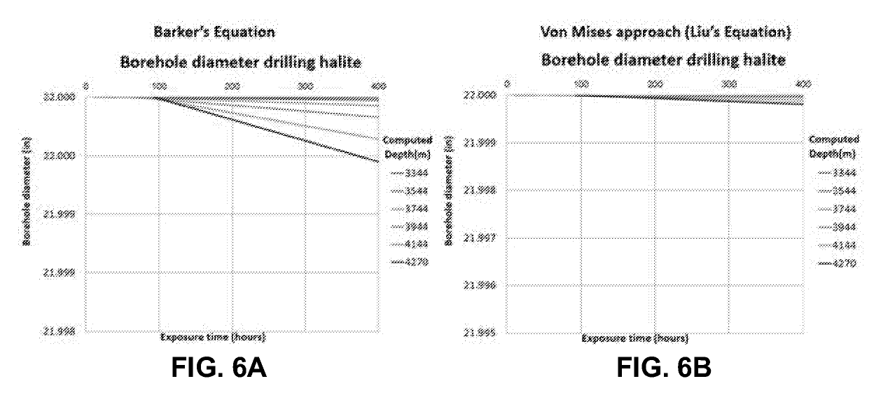

Before and/or during the salt drilling interval, a borehole diameter is estimated based on the real and planned mud weight. FIGS. 6A and 6B shows six depths of the salt interval, for both creep methodologies, considering the same input parameters. Borehole diameter is calculated as a function of expected exposure time in a 100% halite interval. The Barker equation simulation (FIG. 6A) has more salt movement than is seen in the Von Mises elasto-viscoplastic model (FIG. 6B) with the same input data.

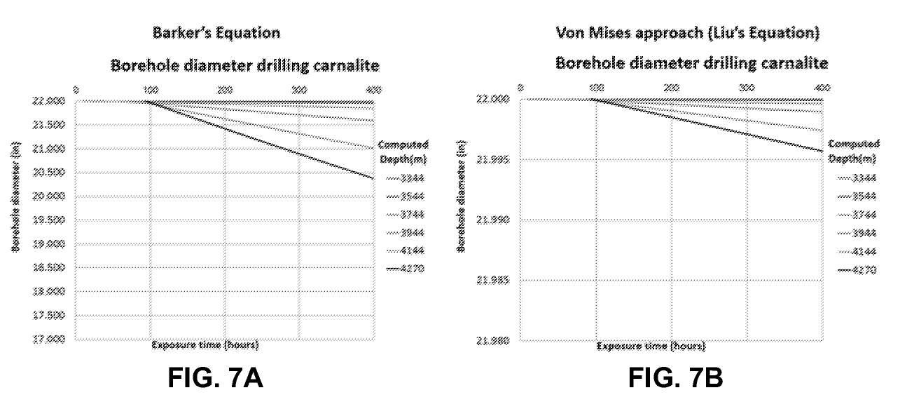

It is also possible to drill salt types other than halite. In such case, the same simulations under same conditions discussed above are calculated assuming carnalite inclusions are present. In FIGS. 7A and 7B, it is seen that carnalite creep behavior using both methodologies is much more aggressive compared to halite. This may be an undesirable scenario for drilling operations, but the effect may depend on the depth at which carnalite inclusions are found and the mud weight being used. Demand for this information is the driver for real-time salt creeping monitoring in which the inputs can be updated to account for real drilling conditions. Depending on the salt creep estimation in the worst-case scenario, some actions can be taken, such as increasing mud weight to decrease the deviatoric stress and monitoring the time of exposure. Having the real-time information enables the drilling operator to have an increased knowledge of salt-creeping effects under different scenarios and to account for a worst-case scenario.

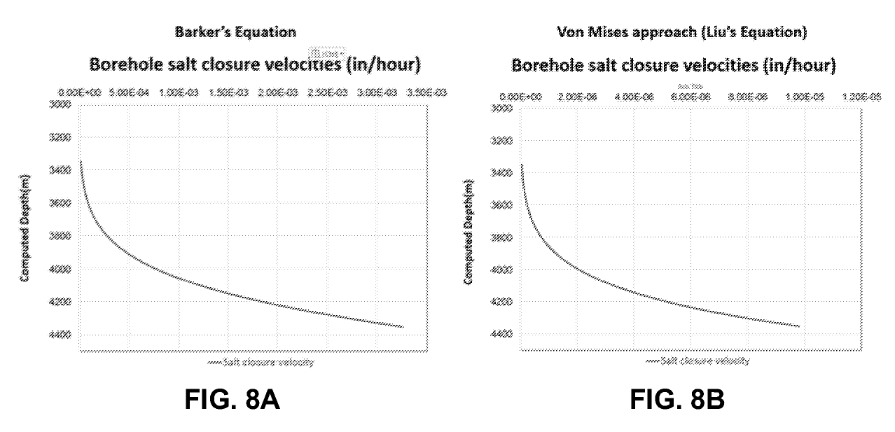

FIGS. 8A and 8B show the creep velocity profile expected in the salt sections. The creep velocity is independent of time exposure and can be interpreted as a salt property that is a function of the depth. Both creep models assume that the creep velocity is constant with time. FIGS. 8A and 8B show the effect of deviatory stresses and temperature since it is calculated with the same mud weight. As the drilling depth increases, the deviatory stress rises as a function of overburden and the temperature increases as a function of geothermal gradient. The graph shows that creep velocity is higher for intervals which are deeper (caused by higher overburden, higher temperature). The creep velocity is different when comparing the Barker and Liu equations. The Barker equation shows higher salt creep velocity than the Von Mises approach.

Drilling parameters monitoring is part of the method 400, used to calibrate the creep model. A high closure velocity of a hole can cause sticking around a bit or stabilizers, increasing the friction and making it difficult to transfer weight to the bit. As a consequence of salt movement, torsional vibration can be produced and torque off bottom can increase, causing to decrease the ROP. Stuck pipe events can also be frequent. The torque behavior together with the presence of stick-slip, shocks and vibrations can be used as salt creep indicators during drilling operations. In case high mud weight are required to maintain a stable wellbore, the risk of stuck pipe due to differential sticking in interbedded permeable zones such as sands needs to be considered.

There may also be a potential for losses when drilling through massive salt bodies, especially when are using high mud weight to control the creep. In general, the losses can be in fractures/salt weld or permeable inclusions in the salt. In a salt formation, open fractures can be associated with a section of low creep velocity. A salt creep model can identify zones with high risk of losses when offset well information is available. The correlation between mud loss events, salt creep model and seismic/geologic interpretation could help identifying the mechanism of losses.

Salt creep monitoring can be applied in massive salt or in a thin salt layer. A thin layer of salt may prove to be more problematic than a massive salt body for drilling operations, because a thin layer might indicate that the salt is highly mobile.

Temperature may be a variable in the accuracy of the creep model. The temperature profile may depend on the shape of the salt body and the regional heat flow. A salt sheet may have a different profile from one with a bulbous or canopy shape. The profile may also depend on where the well may penetrate the salt. The temperature profile may be estimated through the propagation of the thermal gradient from offset wells. The uncertainty of this methodology is proportional to the number of offset wells and the geological correlation. The salt has higher thermal conductivity than shales and sandstones. This thermal property can generate a cooling effect at the base of the salt and a heating effect at the top, influencing the thermal gradient of the adjacent formations. The second methodology to determine the temperature profile is a numerical scheme. If there are no measurements available in the area, and the shape of the salt is known, a numerical scheme may model the temperature distribution in and around the salt, considering a steady-state regime.

When information about salt properties and offset well data is relatively scarce, some events related to salt creep can occur. The model can be recalibrated with this events and a new prognosis is provided to the drillers considering actual ROP. The updated temperature, overburden, mineralogy interpretation and salt creep parameters are checked for consistency and the model is updated. Updated model can help to explain drilling events and help discriminating mechanical events from actual salt creeping events.

Various models to simulate the salt movement exist, and the magnitude of the velocity of strain could be overestimated without a real caliper acquisition and an accurate model update. Post-mortem analysis is used as input data for future analysis and model calibration.

In one or more embodiments, the functions described can be implemented in hardware, software, firmware, or any combination thereof. For a software implementation, the techniques described herein can be implemented with modules (e.g., procedures, functions, subprograms, programs, routines, subroutines, modules, software packages, classes, and so on) that perform the functions described herein. A module can be coupled to another module or a hardware circuit by passing and/or receiving information, data, arguments, parameters, or memory contents. Information, arguments, parameters, data, or the like can be passed, forwarded, or transmitted using any suitable means including memory sharing, message passing, token passing, network transmission, and the like. The software codes can be stored in memory units and executed by processors. The memory unit can be implemented within the processor or external to the processor, in which case it can be communicatively coupled to the processor via various means as is known in the art.

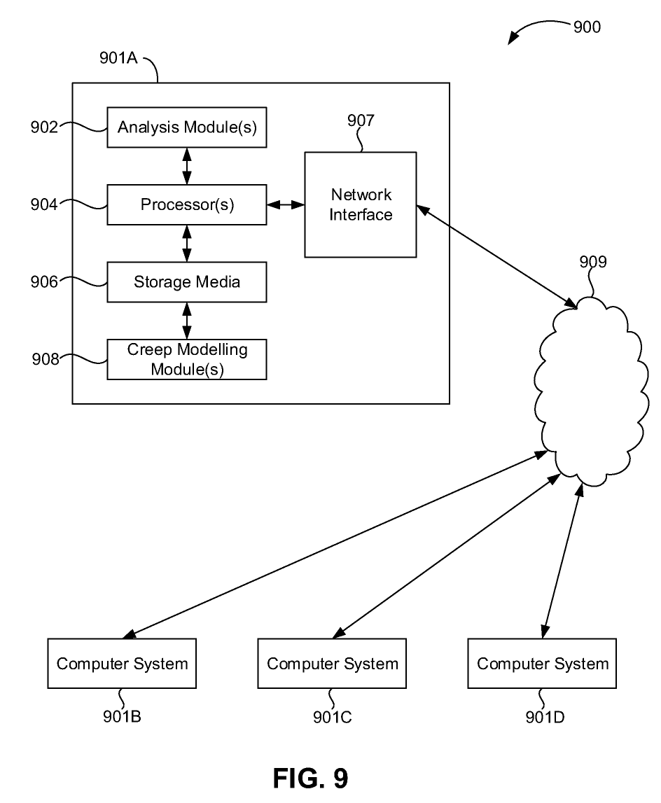

In some embodiments, any of the methods of the present disclosure may be executed by a computing system. FIG. 9 illustrates an example of such a computing system 900, in accordance with some embodiments. The computing system 900 may include a computer or computer system 901A, which may be an individual computer system 901A or an arrangement of distributed computer systems. The computer system 901A includes one or more analysis module(s) 902 configured to perform various tasks according to some embodiments, such as one or more methods disclosed herein. To perform these various tasks, the analysis module 902 executes independently, or in coordination with, one or more processors 904, which is (or are) connected to one or more storage media 906. The processor(s) 904 is (or are) also connected to a network interface 907 to allow the computer system 901A to communicate over a data network 909 with one or more additional computer systems and/or computing systems, such as 901B, 901C, and/or 901D (note that computer systems 901B, 901C and/or 901D may or may not share the same architecture as computer system 901A, and may be located in different physical locations, e.g., computer systems 901A and 901B may be located in a processing facility, while in communication with one or more computer systems such as 901C and/or 901D that are located in one or more data centers, and/or located in varying countries on different continents).

A processor can include a microprocessor, microcontroller, processor module or subsystem, programmable integrated circuit, programmable gate array, or another control or computing device.

The storage media 906 can be implemented as one or more computer-readable or machine-readable storage media. Note that while in the example embodiment of FIG. 9 storage media 906 is depicted as within computer system 901A, in some embodiments, storage media 906 may be distributed within and/or across multiple internal and/or external enclosures of computing system 901A and/or additional computing systems. Storage media 906 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLU-RAY® disks, or other types of optical storage, or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In some embodiments, computing system 900 contains one or more creep modelling module(s) 908. In the example of computing system 900, computer system 901A includes the creep modelling module 908. In some embodiments, a single creep modelling module may be used to perform some or all aspects of one or more embodiments of the methods. In other embodiments, a plurality of creep modelling modules may be used to perform some or all aspects of methods.

It should be appreciated that computing system 900 is only one example of a computing system, and that computing system 900 may have more or fewer components than shown, may combine additional components not depicted in the example embodiment of FIG. 9, and/or computing system 900 may have a different configuration or arrangement of the components depicted in FIG. 9. The various components shown in FIG. 9 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of protection of the invention.

Geologic interpretations, models and/or other interpretation aids may be refined in an iterative fashion; this concept is applicable to embodiments of the present methods discussed herein. This can include use of feedback loops executed on an algorithmic basis, such as at a computing device (e.g., computing system 900, FIG. 9), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. Moreover, the order in which the elements of the methods are illustrated and described may be re-arranged, and/or two or more elements may occur simultaneously. The embodiments were chosen and described in order to best explain the principals of the invention and its practical applications, to thereby enable others skilled in the art to best utilize the invention and various embodiments with various modifications as are suited to the particular use contemplated.

What is claimed is:

1. A method, comprising:
obtaining data representing a subterranean domain, the subterranean domain comprising a salt layer;
obtaining an initial model of salt creep for a well penetrating the salt layer;
generating a second model of salt creep by revising the initial model while drilling the well based on measurements collected in the well; and
determining one or more revised drilling parameters using the second model while drilling the well.

2. The method of claim 1, further comprising updating the second model to account for the one or more revised drilling parameters.

3. The method of claim 1, wherein the initial model is generated prior to drilling the well, the method further comprising determining one or more initial drilling parameters based on the initial model, wherein determining the one or more revised drilling parameters while drilling the well comprises revising the one or more initial drilling parameters.

4. The method of claim 1, further comprising:
generating an exposure time log for one or more depth intervals along the well, wherein the one or more depth intervals include at least a portion of the salt layer; and
calculating vertical stresses, deviatoric horizontal stresses, or both in the subterranean domain,
wherein updating the model comprises using the exposure time log, the vertical stresses, the deviatoric stresses, or a combination thereof.

5. The method of claim 4, further comprising:
generating a torque-drag model based in part on the exposure time log, the vertical stresses, the deviatoric horizontal stresses, or a combination thereof; and
determining a torque experienced during drilling,
wherein updating the model comprises comparing the torque-drag model with the torque experienced in the well.

6. The method of claim 1, wherein the one or more revised drilling parameters include a borehole diameter profile.

7. The method of claim 1, wherein the one or more revised drilling parameters include a mud weight, rate of penetration, or both.

8. The method of claim 1, further comprising determining one or more depth intervals to ream, a casing depth, or both.

9. A computing system comprising:
one or more processors; and
a memory system including one or more non-transitory computer-readable media storing instructions that, when executed by at least one of the one or more processors, cause the computing system to perform operations, the operations comprising:
obtaining data representing a subterranean domain, the subterranean domain comprising a salt layer;
obtaining an initial model of salt creep for a well penetrating the salt layer;
generating a second model of salt creep by revising the initial model while drilling the well based on measurements collected in the well; and
determining one or more revised drilling parameters using the second model while drilling the well.

10. The system of claim 9, wherein the operations further comprise updating the second model to account for the one or more revised drilling parameters.

11. The system of claim 9, wherein the initial model is generated prior to drilling the well, the operations further comprising determining one or more initial drilling parameters based on the initial model, wherein determining the one or more revised drilling parameters while drilling the well comprises revising the one or more initial drilling parameters.

12. The system of claim 9, wherein the operations further comprise:
generating an exposure time log for one or more depth intervals along the well, wherein the one or more depth intervals include at least a portion of the salt layer; and
calculating vertical stresses, deviatoric horizontal stresses, or both in the subterranean domain,
wherein updating the model comprises using the exposure time log, the vertical stresses, the deviatoric stresses, or a combination thereof.

13. The system of claim 12, wherein the operations further comprise:
generating a torque-drag model based in part on the exposure time log, the vertical stresses, the deviatoric horizontal stresses, or a combination thereof; and
determining a torque experienced during drilling,
wherein updating the model comprises comparing the torque-drag model with the torque experienced in the well.

14. The system of claim 9, wherein the one or more revised drilling parameters include a borehole diameter profile.

15. The system of claim 9, wherein the one or more revised drilling parameters include a mud weight, rate of penetration, or both.

16. The system of claim 9, wherein the operations further comprise determining one or more depth intervals to ream, a casing depth, or both.

17. A non-transitory computer-readable medium storing instructions that, when executed by at least one processor, cause a computing system to perform operations, the operations comprising:
obtaining data representing a subterranean domain, the subterranean domain comprising a salt layer;
obtaining an initial model of salt creep for a well penetrating the salt layer;
generating a second model of salt creep by revising the initial model while drilling the well based on measurements collected in the well; and
determining one or more revised drilling parameters using the second model while drilling the well.

18. The medium of claim 17, wherein the operations further comprise updating the second model to account for the one or more revised drilling parameters.

19. The medium of claim 17, wherein the initial model is generated prior to drilling the well, the operations further comprising determining one or more initial drilling parameters based on the initial model, wherein determining the one or more revised drilling parameters while drilling the well comprises revising the one or more initial drilling parameters.

20. The medium of claim 17, wherein the operations further comprise:
generating an exposure time log for one or more depth intervals along the well, wherein the one or more depth intervals include at least a portion of the salt layer;
calculating vertical stresses, deviatoric horizontal stresses, or both in the subterranean domain, wherein updating the model comprises using the exposure time log, the vertical stresses, the deviatoric stresses, or a combination thereof;
generating a torque-drag model based in part on the exposure time log, the vertical stresses, the deviatoric horizontal stresses, or a combination thereof; and
determining a torque experienced during drilling, wherein updating the model comprises comparing the torque-drag model with the torque experienced in the well.
